(19) United States
(12) Patent Application Publication
(10) Pub. No.: US 2022/0324317 A1
(43) Pub. Date: Oct. 13, 2022

(54) Hybrid Drive Train for a Motor Vehicle

(71) Applicant: ZF Friedrichshafen AG, Friedrichshafen (DE)

(72) Inventors: Stefan Beck, Eriskirch (DE); Martin Brehmer, Tettnang (DE); Peter Ziemer, Tettnang (DE); Thomas Kroh, Lindau (DE); Fabian Kutter, Kressbronn (DE); Oliver Bayer, Hörbranz (AT); Johannes Kaltenbach, Friedrichshafen (DE); Matthias Horn, Tettnang (DE); Michael Wechs, Weißensberg (DE); Thomas Martin, Weissensberg (DE); Juri Pawlakowitsch, Kressbronn (DE); Max Bachmann, Friedrichshafen (DE)

(21) Appl. No.: 17/635,134

(22) PCT Filed: Jul. 29, 2020
(86) PCT No.: PCT/EP2020/071328

§ 371 Date: Feb. 14, 2022

(30) Foreign Application Priority Data
Aug. 13, 2019 (DE) 10 2019 212 144.6

(51) Int. Cl. B60K 6/547; B60K 6/442; B60K 6/387

(52) U.S. Cl. CPC B60K 6/547; B60K 6/442; B60K 6/387

(57) ABSTRACT

A hybrid drive train for a motor vehicle includes a drive shaft that is connectable to an internal combustion engine, a first input shaft connected to the drive shaft or connectable to the drive shaft via a first clutch, a second input shaft, an output shaft arrangement, a first electric machine connected to the second input shaft, and a transmission arrangement that includes: (i) a first gear set plane with at least one shiftable gear set via which the first input shaft is connectable to the output shaft arrangement; (ii) a second gear set plane with at least one shiftable gear set via which the second input shaft is connectable to the output shaft arrangement; and (iii) a third gear set plane with at least one gear set via which the output shaft arrangement is connected to a power distribution unit configured for driving driven wheels.

### CROSS-REFERENCE TO RELATED APPLICATIONS

The present application is related and has right of priority to German Patent Application No. 102019212144.6 filed in the German Patent Office on Aug. 13, 2019 and is a nationalization of PCT/EP2020/071328 filed in the European Patent Office on Jul. 29, 2020, both of which are incorporated by reference in their entirety for all purposes.

### FIELD OF THE INVENTION

The present invention relates generally to a hybrid drive train for a motor vehicle, including a drive shaft, to which an internal combustion engine is connectable, a first input shaft, which is connected to the drive shaft or is connectable to the drive shaft via a first clutch, a second input shaft, an output shaft arrangement, a first electric machine, which is connected to a second input shaft, and a transmission arrangement.

### BACKGROUND

Hybrid drive trains for motor vehicles generally include an internal combustion engine, which can provide drive power for driving the motor vehicle, and an electric machine, which can provide drive power for the motor vehicle alternatively or in addition to the internal combustion engine depending on the operating mode.

With respect to hybrid drive trains, a distinction is made between a plurality of different concepts, each of which provides a different connection of the electric machine to the transmission arrangement. In a typical variant of dual-clutch transmissions, an electric machine is to be arranged concentrically to an input element of the dual-clutch assembly. It is also known in the case of dual-clutch transmissions to assign one electric machine to one of the two sub-transmissions.

Moreover, it is known to arrange an electric machine concentrically to a first input shaft, wherein a rotor of the electric machine is connected to a hollow shaft, which is arranged around the first input shaft. The hollow shaft and the input shaft are each connected to an output shaft via a plurality of gear sets (for example, DE 10 2010 030 573 A1 or DE 10 2011 005 451 A1).

It is also known from the aforementioned document DE 10 2011 005 451 A1 to connect a second electric machine directly to the input shaft, and so this second electric machine can be designed, for example, as a starter generator.

Moreover, it is known from the document US 2017/0129323 A1 to equip a hybrid transmission with an internal primary shaft and with a hollow primary shaft, which are arranged concentrically to each other, wherein one primary shaft is connected to an electric machine and wherein the other primary shaft is connected to an internal combustion engine, without providing a separating clutch between the other primary shaft and the internal combustion engine. A secondary shaft is connected to wheels of the vehicle via a differential. Moreover, a transfer shaft is provided in order to transmit a motion from at least one of the primary shafts to the secondary shaft and in order to couple the primary shafts. The electric machine is arranged at an end of the primary shafts positioned axially opposite the internal combustion engine.

The hybrid transmission that was made known by the document US 2017/0129323 A1 enables a plurality of operating modes. In one variant, a second electric machine is connected to the transfer shaft via a gear set. This results in a further plurality of possible operating modes.

### SUMMARY OF THE INVENTION

Example aspects of the invention provide an improved hybrid drive train for a motor vehicle.

According to example aspects of the invention, a hybrid drive train for a motor vehicle includes a drive shaft, to which an internal combustion engine is connectable, a first input shaft connected to the drive shaft or connectable to the drive shaft via a first clutch, a second input shaft, an output shaft arrangement, a first electric machine connected to the second input shaft, and a transmission arrangement, which includes: (i) a first gear set plane with at least one shiftable gear set via which the first input shaft is connectable to the output shaft arrangement; (ii) a second gear set plane with at least one shiftable gear set via which the second input shaft is connectable to the output shaft arrangement; and (iii) a third gear set plane with at least one gear set via which the output shaft arrangement is connected to a power distribution unit for driving driven wheels, such as a differential.

The hybrid drive train according to example aspects of the invention is conceptually configured for achieving an axially particularly compact design.

The hybrid drive train is therefore suited, in particular, for the front-rear transverse installation in a motor vehicle.

The first electric machine is preferably arranged coaxially to the second input shaft. The second input shaft is preferably arranged coaxially to the first input shaft. The second input shaft is preferably designed as a hollow shaft, which accommodates at least one section of the first input shaft.

Preferably, the transmission arrangement includes precisely one first gear set plane and/or precisely one second gear set plane. Moreover, the third gear set plane is preferably also an individual gear set plane, via which drive power is transmitted to the power distribution unit.

Overall, the hybrid drive train preferably includes precisely three gear set planes. Moreover, the hybrid drive train according to example aspects of the invention preferably includes precisely two clutch planes, in which clutches are arranged. The clutch planes are preferably arranged axially adjacent to the first gear set plane and to the second gear set plane.

In some example embodiments, the drive shaft is rotationally fixed to the first input shaft. In other example embodiments, the drive shaft and the first input shaft are connected to each other via a first clutch, and so an internal combustion engine connected to the drive shaft is decoupleable from the first input shaft.

The first clutch can be a form-locking clutch, such as, for example, a dog clutch. The first clutch can also be a friction clutch, however. In the case of a design of the first clutch as a friction clutch, it is advantageous that this can also be disengaged under load, for example, during a full brake application or in the case of a malfunction of the internal combustion engine. Moreover, it is possible in this case to also engage the first clutch at a differential speed, and so a “flywheel start” of the internal combustion engine is possible.

For this purpose, the hybrid drive train is capable of establishing a driving operation under purely internal combustion engine power and, in fact, in particular via the first gear set plane. Moreover, for this purpose, the hybrid drive train is capable of establishing a driving operation under purely electric motor power by the first electric machine and, in fact, preferably via the second gear set plane.

Moreover, a hybrid traveling mode is implementable, in which drive power of the internal combustion engine and of the first electric machine is added up and/or superimposed via the output shaft arrangement. In many cases, it is also possible to carry out powershifts in a driving operation under purely internal combustion engine power, in which the first electric machine transmits drive power onto the output shaft arrangement in a manner supporting tractive force, while, for example, the first clutch is disengaged.

In the cases, in which drive power is transmitted from the internal combustion engine onto the output shaft arrangement via the first gear set plane, the first electric machine can be decoupled preferably for the case in which no gear set has been engaged and/or no associated gearshift clutch has been engaged in the second gear set plane. An efficient driving operation under internal combustion engine power is possible in this way.

In the same way, in a driving operation under electric motor power, even for the case in which a first clutch is not provided, the internal combustion engine can be decoupled, in particular for the case in which no gear set has been engaged and/or no associated gearshift clutch has been engaged in the first gear set plane.

A shiftable gear set is to be understood in the present case, in particular, to be a pair made up of an idler gear and a fixed gear, wherein the idler gear is connectable to the associated shaft by a gearshift clutch (generally a form-locking clutch such as a dog clutch or a synchronous gearshift clutch).

In cases, in which the output shaft arrangement includes a single output shaft, for example, one fixed gear is arranged at the input shaft or at the output shaft, and the idler gear is arranged at the other shaft and is in engagement (intermeshes) with the fixed gear.

For the case in which the output shaft arrangement includes two output shafts, which are arranged in parallel to and offset from each other, two shiftable gear sets can also be included in one gear set plane, in particular for the case in which, for example, one fixed gear is fixed at an input shaft, which is in engagement with an idler gear at the first output shaft as well as with an idler gear at the second output shaft (a “dual use” of the fixed gear).

According to one preferred example embodiment, the first input shaft and the second input shaft are connectable to each other via a second clutch.

The second clutch is preferably arranged coaxially to the input shafts. Via the second clutch, it is possible, for example, to establish a driving operation under internal combustion engine power not only via the first gear set plane. Rather, it is also possible not to engage the gear set or the gear sets of the first gear set plane (i.e., disengage the associated gearshift clutches) and, instead, engage the second clutch and engage a gearshift clutch that is associated with a gear set of the second gear set plane.

In this case, the first electric machine is generally entrained in the driving operation under internal combustion engine power. Preferably, the gear step established in this way is a first gear step and/or a starting gear step, however, which is only relatively rarely established, and so, as a result, a considerable loss of efficiency is not to be expected. In addition, it is possible, specifically during the starting operation, to utilize the first electric machine in an assisting manner, without the need to guide drive power over the first gear set plane.

Via the second clutch, the first electric machine can start the internal combustion engine at a standstill.

As mentioned above, the output shaft arrangement can include a single output shaft.

It is particularly preferred, however, when the output shaft arrangement includes a first output shaft and a second output shaft. The two output shafts are preferably arranged axially parallel to the input shaft arrangement, which is formed by the first input shaft and the second input shaft.

A transmission arrangement including an input shaft arrangement and two axially parallel output shafts is often referred to as a three-shaft transmission. This can be axially particularly short and is suited, in particular, for the transverse installation in a motor vehicle.

It is particularly preferred when the first gear set plane includes a fixed gear, which is connected to the first input shaft, an idler gear mounted at the first output shaft, and an idler gear mounted at the second output shaft.

Therefore, two shiftable gear sets are integrated in the first gear set plane, namely, on the one hand, the gear set including the fixed gear and the idler gear at the first output shaft. The second gear set is the same fixed gear together with the idler gear at the second output shaft. Since the one fixed gear is in engagement with two idler gears, this is also referred to as a “dual use”.

The idler gears of the first gear set plane are preferably each shiftable idler gears, which are connectable to the associated output shaft by particular gearshift clutches. The gearshift clutches utilized for this purpose, for example, dog clutches or synchronous gearshift clutches, can be actuated by separate actuation devices.

Preferably, the gearshift clutches of the two idler gears are each designed in such a way that the two gearshift clutches are also actuatable by a single actuation device. The two gearshift clutches of the first gear set plane then form a spatially separated gearshift clutch assembly, which includes an actuation device, which can bring the gearshift clutches either both into a neutral position, into a first engagement position, in which the first idler gear is connected to the associated output shaft, and, alternatively, into a second engagement position, in which the second idler gear is connected to the associated second output shaft.

In a corresponding way, the second gear set plane includes a fixed gear connected to the second input shaft, an idler gear mounted at the first output shaft, and an idler gear mounted at the second output shaft.

In the above-described way, via the first input shaft, at least two gear steps can be established by the first gear set plane, and/or two gear steps starting from the second input shaft can be established by the second gear set plane.

The idler gears of the second gear set plane can be connected to the associated output shafts by particular gearshift clutches. As is the case with the first gear set plane, two actuation devices can be utilized for this purpose, or a single actuation device can be utilized, which brings the two gearshift clutches either jointly into a neutral position or into a first engagement position, in which the first idler gear is connected to the associated first output shaft or, alternatively, into a second engagement position, in which the second idler gear is connected to the second output shaft.

It is understood that, in the first gear set plane as well as in the second gear set plane, only one of the two idler gears can be connected to the associated output shaft in each case, and the other idler gear of the same gear set plane can then not be connected to the associated output shaft in any case.

It is particularly preferred, furthermore, when the third gear set plane includes an output gearwheel fixed at the first output shaft and a second output gearwheel fixed at the second output shaft, which are in engagement with an input element of the power distribution unit.

The input element of the power distribution unit can be, for example, an input gear of a differential cage. Via the third gear set plane, therefore, drive power can be transferred from the first output shaft and/or from the second output shaft onto the power distribution unit.

Overall, it is also preferred when the third gear set plane includes an idler gear that is rotatably mounted at the first output shaft and is in engagement with a fixed gear that is fixed at an output shaft of the output shaft arrangement.

Due to this example embodiment, one further shiftable gear set is formed, which is associated with the first input shaft. Therefore, it is possible in this way, starting from the first input shaft, to establish at least three different gear steps, without the need to involve the second gear set plane. Rather, all gearshift clutches of the second gear set plane can be disengaged. Of the three gear steps, two gear steps are associated with the first gear set plane, and the third gear step is associated with the gear set that is formed by the idler gear mounted at the first input shaft and the fixed gear at the output shaft.

The idler gear at the first input shaft is preferably connectable to the first input shaft by one further gearshift clutch.

It is particularly preferred when the idler gear rotatably mounted at the first input shaft is connectable to the first input shaft by a gearshift clutch and when this gearshift clutch and a second clutch, via which the first input shaft and the second input shaft are connectable to each other, are alternately actuatable by a single actuation device.

The gearshift clutch and the second clutch form a gearshift clutch assembly, which can be brought into a neutral position, in which neither the gearshift clutch nor the second clutch is disengaged. Moreover, alternatively, either the gearshift clutch or the second clutch can be engaged by the single actuation device.

Due to this measure, the installation space requirement for clutches and gearshift clutches can be reduced overall.

In general, it is conceivable to arrange the three gear set planes axially in relation to one another in any way. It is particularly preferred, however, when the third gear set plane is arranged in the axial direction between the first gear set plane and the second gear set plane.

As a result, the first gear set plane can be arranged spatially adjacent to the internal combustion engine to be connected and the second gear set plane can be arranged spatially adjacent to the first electric machine.

The clutches for actuating the gear sets as well as the first clutch and/or the second clutch can be arranged, in any way, in spatial assignment to the particular elements to be engaged.

It is particularly preferred, however, when a first clutch plane is arranged adjacent to the first gear set plane and, in fact, preferably on an axial side of the first gear set plane facing away from the third gear set plane.

The gearshift clutches for the idler gears of the first gear set plane can then be arranged in the first clutch plane. Moreover, the first clutch can be optionally arranged in the first clutch plane.

For this example embodiment, the first gear set plane and the third gear set plane are preferably arranged directly axially adjacent to each other.

According to one further preferred example embodiment, a second clutch plane is arranged adjacent to the second gear set plane and, in fact, preferably in the axial direction between the second gear set plane and the third gear set plane.

Preferably, gearshift clutches for shifting the idler gears of the second gear set plane are arranged in the second clutch plane. Moreover, the gearshift clutch for shifting the idler gear mounted at the first input shaft and/or the second clutch can be arranged in the second clutch plane. The latter two clutches are preferably integrated into a gearshift clutch assembly that is arranged coaxially to the input shaft arrangement.

The first clutch plane and the second clutch plane each include at least one gearshift clutch or any other clutch preferably on each axis (the input shaft arrangement axis and the axes of the output shafts).

Therefore, it is possible to arrange all clutches of the hybrid drive train in these two clutch planes.

It is particularly preferred when the hybrid drive train therefore includes precisely three gear set planes, namely the first gear set plane, the second gear set plane, and the third gear set plane, as well as two clutch planes, namely the first clutch plane and the second clutch plane.

The first clutch plane is preferably directly adjacent to the drive shaft and to the internal combustion engine. The second gear set plane is preferably directly axially adjacent to the first electric machine.

The hybrid drive train enables driving under purely internal combustion engine power, in which the first electric machine is decoupled. All gear sets of the second gear set plane are not engaged in this case. Power flows either from the first input shaft via the first gear set plane or via the idler gear mounted at the first input shaft to the output shaft arrangement. The first electric machine is decoupled in this case in order to be able to increase the efficiency.

A driving operation under purely electric motor power by the first electric machine is possible in a similar way. The aforementioned gearshift clutches, by which a driving operation under purely internal combustion engine power can be established, are disengaged in this case. Power flows from the second input shaft via the second gear set plane to the output shaft arrangement.

If the second clutch is provided, which can connect the first input shaft and the second input shaft to each other, it is also possible to implement the following preferred example embodiments. In this case, a gear set of the second gear set plane can always be utilized namely as the first gear step and/or the starting gear step. This can be formed, for example, by a fixed gear, which is connected to the second input shaft, and an idler gear of the second gear set plane.

In this case, power can flow from the output shaft or the first input shaft via the engaged second clutch onto the second input shaft and, from there, via the starting torque ratio, onto the output shaft arrangement. The first electric machine is generally entrained in this case. Since a driving operation in the first gear step takes place only relatively rarely, however, as compared to the overall driving operation of the vehicle, the efficiency is not significantly reduced as a result. In addition, the first electric machine can be switched to idling for this case, and so the drag losses are low.

Therefore, for a driving operation under internal combustion engine power, preferably four gear steps can be implemented, namely a first gear step having the starting torque ratio via the gear set of the second gear set plane (with the second clutch engaged), and the three gear steps, which can be implemented by the first gear set plane and/or the idler gear mounted at the first input shaft and the associated fixed gear at the output shaft.

Theoretically, it is also conceivable to implement one further gear step via a second gear set of the second gear set plane. This is generally not necessary or useful, however, for reasons related to ratio adaptation.

A driving operation under purely electric motor power is implementable by the first electric machine in at least two gear steps, which are establishable by the second gear set plane. Provided the second clutch and the first clutch are present, the second input shaft can also be connected to the first input shaft and the first input shaft can be decoupled from the internal combustion engine. Therefore, the gear steps of the first gear set plane can also be utilized for a driving operation under purely electric motor power.

In a driving operation under purely internal combustion engine power, the first electric machine can transmit power onto the output shaft arrangement in a manner supporting tractive force. Interruptions of tractive force during gear ratio changes can therefore be reduced. In general, at least the gearshift clutches that are associated with the first gear set plane and that are associated with the idler gear at the first input shaft arrangement are to be implemented as synchronous gearshift clutches. This is the case because the first electric machine can generally not ensure a synchronization at the gearshift clutches in the driving operation under internal combustion engine power. This can possibly take place, however, by a second electric machine, which is connected to the first input shaft.

Therefore, it is preferred when a second electric machine is connected to the first input shaft.

The connection is preferably implemented in such a way that the second electric machine is arranged axially parallel to the input shaft arrangement and the output shaft. An input pinion of the second electric machine is preferably in engagement with a fixed gear that is fixed at the first input shaft. If necessary, yet another intermediate gear can be arranged therebetween in order to be able to even better adapt the ratio.

The second electric machine is preferably arranged in axial overlap with at least the third gear set plane and the second clutch plane. Preferably, the second electric machine does not extend past the transmission arrangement in the axial direction.

The second electric machine can be utilized for a boost mode in the driving operation under internal combustion engine power. A driving operation under purely electric motor power can also be established by the second electric machine, however. The gear steps are the same as in the driving operation under purely internal combustion engine power.

Moreover, the second electric machine can be utilized for the clutch synchronization in the driving operation under internal combustion engine power and/or in the driving operation under electric motor power by the first electric machine. The associated gearshift clutches can therefore be implemented as dog clutches. The first clutch and/or the second clutch can also be implemented as a dog clutch.

Accordingly, it is preferred when a first clutch and/or a second clutch and/or at least one gearshift clutch are/is implemented as a dog clutch.

In general, it is conceivable to design the first electric machine with a hollow rotor, which is rigidly connected to the second input shaft.

In one preferred example embodiment, the rotor of the first electric machine can also be connected to the second input shaft via a pre-ratio, however. Here, the pre-ratio can include, for example, a planetary gear set, which is arranged concentrically to the second input shaft. Preferably, a ring gear of the planetary gear set is connected to the rotor and a planet carrier is preferably rigidly connected to the second input shaft. A sun gear of the planetary gear set can be connected, for example, to a housing.

Overall, depending on the example embodiment, at least one of the following advantages can be achieved with the hybrid drive train: a simple configuration in combination with a compact design results; low component loads result; low transmission losses result; a good gearing efficiency results; a good transmission ratio range can be implemented; in the simplest case, only three actuators and/or actuation devices are necessary; or four actuators if the first clutch is present.

Preferably, five spur gear stages for five gears are installed in the first gear set plane and the second gear set plane as well as in the third gear set plane; preferably only four of these gears are utilized for the internal combustion engine, however. One of the gears for the driving operation under electric motor power by the first electric machine is also utilized as a first and/or starting gear for the internal combustion engine with the second gearshift clutch engaged.

This has the advantage that all four internal combustion engine gears are “re-startable”, i.e., the internal combustion engine can be engaged during a driving operation under purely electric motor power in the starting gear step in each case, in that only one further gearshift clutch is engaged.

A second ratio of the second gear set plane is typically utilized only at higher speeds, at which the first gear is not needed anyway for the driving operation under internal combustion engine power.

It is understood that the features, which are mentioned above and which will be described in greater detail in the following, are usable not only in the particular combination indicated, but rather also in other combinations or alone, without departing from the scope of the present invention.

### BRIEF DESCRIPTION OF THE DRAWINGS

Exemplary embodiments of the invention are represented in the drawing and are explained in greater detail in the following description, wherein

FIG. 1 shows a schematic of a first example embodiment of a hybrid drive train according to the invention;

FIG. 2 shows a power flow diagram of the hybrid drive train from FIG. 1;

FIG. 3 shows a gearshift table for internal combustion engine gear steps of the hybrid drive train from FIG. 1;

FIG. 4 shows a gearshift table for electric motor gear steps of the hybrid drive train from FIG. 1;

FIG. 5 shows one further example embodiment of a hybrid drive train according to the invention; and

FIG. 6 shows one further example embodiment of a hybrid drive train according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

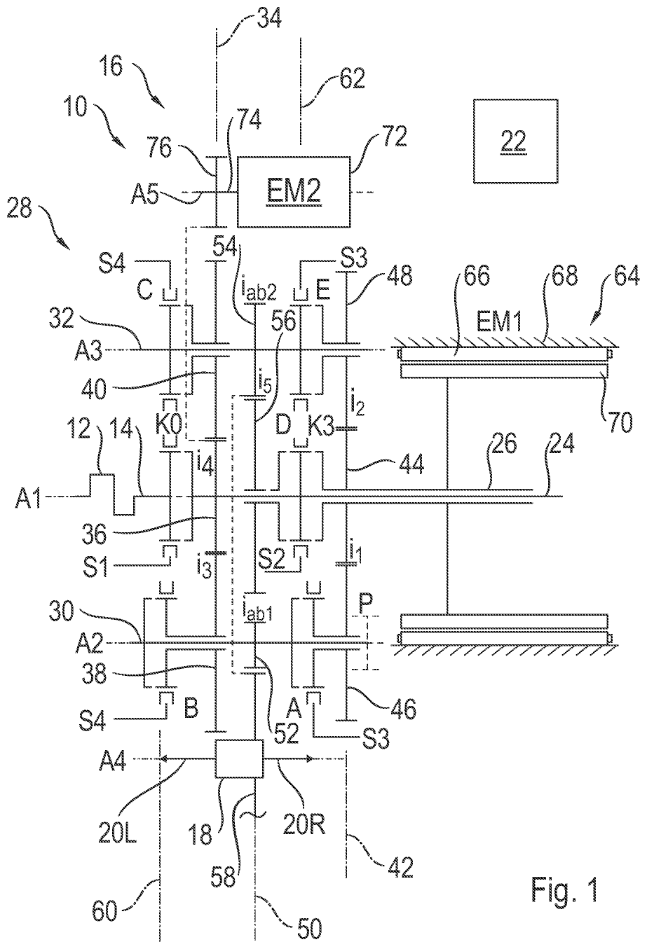

In FIG. 1, a hybrid drive train for a motor vehicle, in particular a passenger car, is diagrammatically represented and is labeled, in general, with 10.

The hybrid drive train 10 includes an internal combustion engine 12, the crankshaft of which is fixedly connected to a drive shaft 14.

The hybrid drive train 10 includes, furthermore, a hybrid transmission arrangement 16, which can guide drive power provided by the drive shaft 14 onto a power distribution unit 18, which is designed for distributing drive power onto driven wheels 20L, 20R of the motor vehicle.

Moreover, the hybrid drive train 10 includes a control device 22 for controlling various components of the hybrid drive train of the type explained in the following.

The hybrid drive train 16 includes a first input shaft 24, which is arranged coaxially to the drive shaft 14. Moreover, the hybrid transmission arrangement 16 includes a second input shaft 26, which is arranged coaxially to the first input shaft 24 and, in fact, in the form of a hollow shaft, which is arranged, at least in sections, around the first input shaft 24.

The hybrid transmission arrangement 16 includes, furthermore, an output shaft arrangement 28 including a first output shaft 30 and a second output shaft 32. The first and the second output shafts 30, 32 are arranged axially parallel to the input shaft arrangement, which is formed by the first input shaft 24 and the second input shaft 26.

The hybrid transmission arrangement 16 includes, furthermore, a first gear set plane 34. The first gear set plane 34 includes a fixed gear 36, which is fixedly connected to the first input shaft 24, an idler gear 38, which is rotatably mounted at the first output shaft 30, and an idler gear 40, which is rotatably mounted at the second output shaft 32. The idler gears 38, 40 are both in engagement with the fixed gear 36.

Moreover, the hybrid transmission arrangement 16 includes a second gear set plane 42. The second gear set plane 42 includes a fixed gear 44, which is fixedly connected to the second input shaft 26, an idler gear 46, which is rotatably mounted at the first output shaft 30, and an idler gear 48, which is rotatably mounted at the second output shaft 32. The idler gears 46, 48 are both in engagement with the fixed gear 44.

Moreover, the hybrid transmission arrangement 16 includes a third gear set plane 50. The third gear set plane 50 includes a first output gearwheel 52, which is fixedly connected to the first output shaft 30, and a second output gearwheel 54, which is fixedly connected to the second output shaft 32. Moreover, the third gear set plane 50 includes an idler gear 56, which is rotatably mounted at the first input shaft 24 and is in engagement with the second output gearwheel 54.

An input element of the power distribution unit 18 is formed by a drive gear 58, which is in engagement with the first output gearwheel 52 as well as with the second output gearwheel 54.

The hybrid transmission arrangement 16 includes, furthermore, a first clutch plane 60. The first clutch plane 60 includes a gearshift clutch B, by which the idler gear 38 is connectable to the first output shaft 30, and a gearshift clutch C, by which the idler gear 40 is connectable to the second output shaft 32.

In the present case, the first clutch plane 60 includes, furthermore, a first clutch K0, which is arranged between the output shaft 14 and the first input shaft 24 and, in fact, coaxially thereto. The first clutch K0 therefore forms a separating clutch between the hybrid transmission arrangement 16 and the internal combustion engine 12.

The hybrid transmission arrangement 16 includes, furthermore, a second clutch plane 62. The second clutch plane 62 includes a gearshift clutch A, by which the idler gear 46 is connectable to the first output shaft 30, and a gearshift clutch E, by which the idler gear 48 is connectable to the second output shaft 32.

Moreover, the second clutch plane 62 includes a gearshift clutch D, by which the idler gear 56 is connectable to the first input shaft 24. The gearshift clutch D and a second clutch K3 form, in the present case, a gearshift clutch assembly, which is arranged in the second clutch plane 62 and is designed for engaging either the gearshift clutch D or the second clutch K3. Moreover, the gearshift clutch assembly can establish a neutral position, in which neither the gearshift clutch D nor the second clutch K3 is engaged.

The input shaft arrangement is situated on an axis A1. The first output shaft 30 is situated on an axis A2. The second output shaft 32 is situated on an axis A3. The power distribution unit 18 is situated on an axis A4.

The following actuation devices are provided for actuating the gearshift clutches A through E as well as the first clutch K0 and the second clutch K3: A first actuation device S1 is designed for disengaging or engaging the first clutch K0. A second actuation device S2 is designed for either engaging the gearshift clutch D or engaging the second clutch K3 or establishing a neutral position therebetween, in which neither D nor K3 is engaged.

A third actuation device S3 is associated with the gearshift clutches A and E and is designed for either engaging the gearshift clutch A or engaging the gearshift clutch E or establishing a neutral position, in which neither the gearshift clutch A nor the gearshift clutch E is engaged.

A fourth actuation device S4 is associated with the gearshift clutches B and C. The fourth actuation device S4 is designed for either engaging the gearshift clutch B or engaging the gearshift clutch C or establishing a neutral position, in which neither the gearshift clutch B nor the gearshift clutch C is engaged.

The third gear set plane 50 is arranged in the axial direction between the first gear set plane 34 and the second gear set plane 42. The first clutch plane 60 is arranged on a side of the first gear set plane 34 axially opposite the third gear set plane 50. The second clutch plane 62 is arranged in the axial direction between the second gear set plane 42 and the third gear set plane 50.

Starting from the side of the internal combustion engine 12, the order of the planes is, therefore, as follows: 60, 34, 50, 62, 42.

The hybrid transmission arrangement 16 includes, furthermore, a first electric machine 64 (EMI). The first electric machine 64 is arranged coaxially to the input shaft arrangement 24, 26 and is axially arranged on a side of the second gear set plane 42 opposite the second clutch plane 62. In other words, the internal combustion engine 12 and the first electric machine 64 are arranged on axially opposite sides of the hybrid drive train 10.

The first electric machine 64 includes a stator 66, which is fixedly connected to a housing 68. Moreover, the first electric machine 64 includes a rotor 70, which is rigidly connected to the second input shaft 26.

The hybrid transmission arrangement 16 includes, furthermore, a second electric machine 82 (EM2). The second electric machine 72 includes an electric machine shaft 74, which is axially parallel to and offset from the input shaft arrangement 24, 26 and the output shafts 30, 32. A gearwheel 76 is fixed at the electric machine shaft 74 and is in engagement with the fixed gear 36 of the first gear set plane 34. The second electric machine 72 is therefore connected to the first input shaft 24.

The second electric machine 72 is arranged on an axis A5.

In FIG. 1, it is indicated, furthermore, that a parking interlock gear P can be fixedly connected to one of the output shafts 30, 32 in order to establish a parking lock function, in the present case to the first output shaft 30 and, in fact, in the axial direction between the second gear set plane 42 and the first electric machine 64. The parking interlock gear P can also be arranged at another point, however, for example, at the second output shaft 32 and, in fact, at any point as viewed in the axial direction.

The hybrid drive train 10 therefore includes seven pairs of spur gears and seven gear change elements (first and second clutches K0, K3 and five gearshift clutches A through E). Moreover, the hybrid drive train has five axes A1 through A5 and two output shafts 30, 32. Moreover, the hybrid drive train preferably includes two electric machines 64, 72.

The rated power of the first electric machine 64 is preferably greater than the rated power of the second electric machine 74.

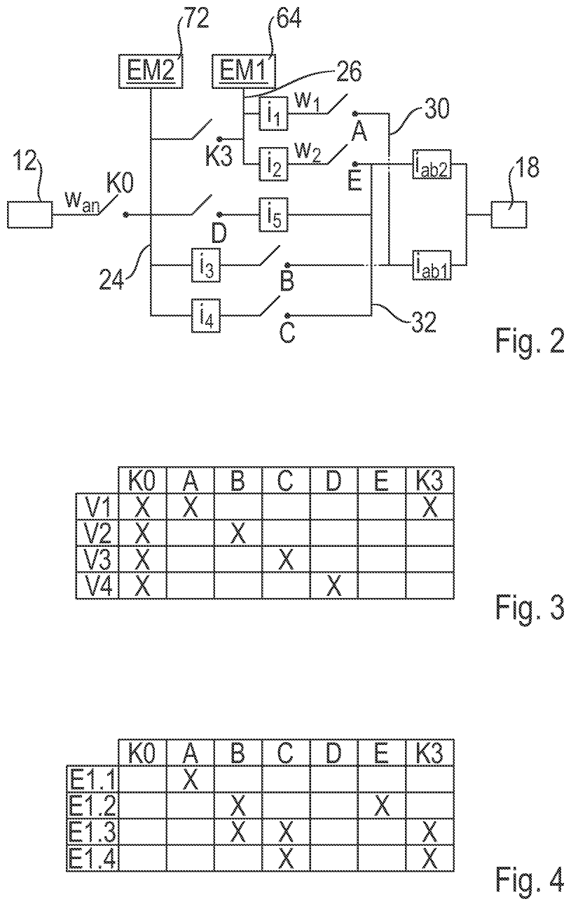

In FIG. 2, the hybrid drive train 10 is represented in such a way that the power flow is apparent. For example, power can flow from the internal combustion engine 12 via the first clutch K0 and the gearshift clutch D to the power distribution unit 18, or from the first electric machine 64 via the engaged second clutch K3 and the gearshift clutch B to the power distribution unit 18, to name a few examples.

FIG. 3 shows a gearshift table for internal combustion engine gear steps V1 through V4. In all these gear steps, the clutch K0 (if provided) is engaged (indicated by an X in the gearshift table from FIG. 3).

An internal-combustion-engine starting gear step V1 is established, in that the gearshift clutch A and the second clutch K3 are additionally engaged. Power flows from the internal combustion engine via the first input shaft 24 and the second clutch K3 to the gearshift clutch A and, from there, to the first output shaft 30. The ratio established as a result is i₁. The output ratio i_{ab1} is also established. These ratios, which will not be referenced in greater detail in the following, are represented in FIGS. 1 and 2.

The second internal combustion engine gear step V2 is established by engaging the gearshift clutch B (the second clutch K3 is disengaged again in this case).

The internal combustion engine gears V3 and V4 are established by engaging the gearshift clutches C and D, respectively.

A driving operation under purely electric motor power by the second electric machine 72 is established in the same way as represented in FIG. 3, wherein, however, the first clutch K0 is disengaged in order to not need to entrain the internal combustion engine 12.

In FIG. 4, a gearshift table for a driving operation under electric motor power by the first electric machine 64 is represented. A starting gear step E1.1 is established, in that exclusively the gearshift clutch A is engaged. In all these electric motor gears E1.1 through E1.4, the first clutch K0, if present, remains disengaged.

A second electric motor gear step E1.2 is established by engaging the gearshift clutch E.

A third electric motor gear step E1.3 is established by engaging the gearshift clutches B, C and the second clutch K3.

A fourth electric motor gear step E1.4 is established by engaging the gearshift clutch C and the second clutch K3.

The hybrid transmission arrangement 16 does not have a dedicated reverse gear. An operation in reverse is generally established by the first electric machine 64 and/or by the second electric machine 72.

Driving can take place purely electrically with both electric machines 64, 72. Powershifts are possible in the purely electric driving operation, in that the first electric machine 64 supports the tractive force when the second electric machine 72 shifts, and vice versa. A shift sequence of this type is described in detail in the document DE 10 2011 005 451 A1 mentioned at the outset.

In the internal-combustion-engine or hybrid mode, the first clutch K0 always remains engaged. Therefore, the internal combustion engine 12 is always connected to the second electric machine 72.

The following functions can be covered with the second electric machine 72:

internal combustion engine start during purely electric driving;

supply of the main power circuit;

serial creeping and driving forward/backwards; and

support of the closed-loop control of the rotational speed of the internal combustion engine during coupling and during gear shifts.

In particular, the internal combustion engine can be coupled into all forward gear steps V1 through V4 when the first electric machine 64 utilizes the gear step E1.1. The internal combustion engine can be coupled into the internal combustion engine gear steps V2 through V3 when the first electric machine 64 utilizes the gear step E1.2. The second electric machine 64 can provide support during the unloading of the shift elements K3, B, C, D, in that the second electric machine 72 operates as a generator. The generated current can be utilized by the first electric machine 64 for supporting tractive force.

The following functions can be covered with the first electric machine 64:
an electric vehicle drive for pulling away from rest and driving forward/backwards; and
supporting the tractive force during gear shifts under internal combustion engine power.

The first electric machine 64 can maintain the tractive force via E1.1 or E1.2 when a change-over takes place at the shift elements K3, B, C, D. The first electric machine 64 can be connected to the internal combustion engine 12 via the shift element K3. In this way, the first electric machine 64 can start the internal combustion engine or act as a generator in order to generate power for a consumer, for example, when the vehicle is stationary.

A powershift from V1 to V2 is carried out in the hybrid mode as follows:
The starting point is, for example, the gear step V1, in which K0, K3, and A are engaged. Thereafter, a load reduction takes place at the shift element K3 and a simultaneous load build-up takes place at the first electric machine 64. The load reduction can take place, in that the internal combustion engine 12 and the second electric machine 72 reduce the torque or when the second electric machine 72 compensates for the internal combustion engine torque while acting as a generator, and so the sum of the torques of the internal combustion engine 12 and of the second electric machine 72 is approximately zero. Thereafter, the shift element K3 is disengaged. Thereupon, the rotational speed of the internal combustion engine 12 and of the second electric machine 72 is reduced, and so the shift element B is synchronized. For this purpose, the second electric machine 72 can operate, for example, as a generator (which is preferred), or the internal combustion engine 12 can enter the coasting condition. Finally, the shift element B can be engaged in order to engage the forward gear step V2.

In the hybrid mode, a reduction of the rotational speed of the first electric machine 64 is also possible. When the second clutch K3 is disengaged, a change-over from the first electric machine 64 to the second electric machine 72 can take place in the background without load. As a result, the rotational speed of the first electric machine 64 is reduced. This change-over can take place while the internal combustion engine 12 (and/or the second electric machine 72) maintain(s) the tractive force in one of the gears V2 through V4.

In the hybrid mode, the first electric machine 64 can be decoupled when the internal combustion engine 12 utilizes one of the gears V2 through V4. In this way, an efficient driving operation under internal combustion engine power is possible.

The second electric machine 72 can be dimensioned smaller, if necessary, than the first electric machine 64, since the second electric machine 72 does not need to perform essential driving functions.

The aforementioned example variants also apply for the case in which a first clutch K0 is not present, i.e., the output shaft 14 is rigidly connected to the first input shaft 24.

Due to the measure that the second electric machine 72 is connected to the fixed gear 36 of the first gear set plane 34, a separate fixed gear is not necessary therefor.

Further example embodiments of hybrid drive trains, which generally correspond to the hybrid drive train 10 from FIGS. 1 through 4 with regard to configuration and mode of operation, are described below. Identical elements are therefore labeled with identical reference characters. In the following, essentially, the differences are explained.

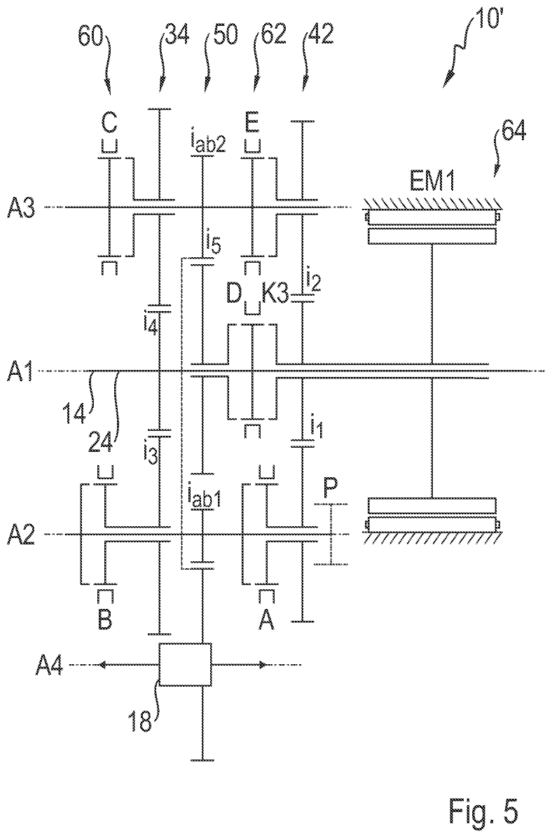

In FIG. 5, a simplified example hybrid drive train 10′ is represented, which includes neither a second electric machine 72 nor a first clutch K0. As compared to the example hybrid drive train 10 from FIGS. 1 through 4, the following driving operations are then inherently no longer possible: a serial driving operation (a serial driving operation is understood, in general, to mean that, when two electric machines are present, a driving operation is established by one electric machine and the internal combustion engine is utilized for operating the other electric machine as a generator and recharging the battery).

An internal combustion engine start during purely electric driving is also not possible. A purely electric powershift is also not possible. A support of the closed-loop control of the rotational speed of the internal combustion engine during coupling and during gear shifts is also not possible.

Otherwise, the hybrid drive train 10′ can also perform all the aforementioned functions.

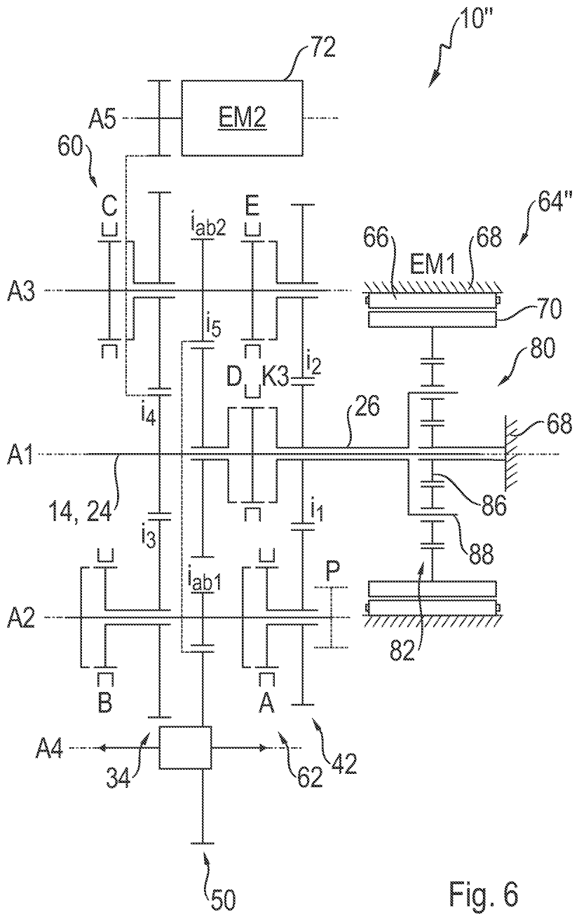

One further example hybrid drive train 10″ is represented in FIG. 6. This corresponds to the example hybrid drive train from FIG. 1, wherein a first clutch K0 is not provided, however. One further difference is that the first electric machine 64″ is not directly connected with the rotor 70 of the first electric machine 64″ to the second input shaft 26. Rather, the rotor 70 of the first electric machine 64″ is connected to the second input shaft 26 via a pre-ratio 80.

In the present case, the pre-ratio 80 is implemented by a planetary gear set 82, which includes a ring gear 84, a sun gear 86, and a planet carrier 88. The ring gear 84 is connected to the rotor 70. The sun gear 86 is fixed at the housing 68. The planet carrier 88 is connected to the second input shaft 26.

In all the aforementioned example embodiments, the first clutch K0, which, as is also the case for the gearshift clutches A through E and the second clutch K3, can be designed as a dog clutch (in particular when the second electric machine 72 is present), and can also be implemented as a friction clutch. In this case, it is advantageous that the first clutch K0 can also be disengaged under load, for example, during a full brake application or in the case of a malfunction in the internal combustion engine 12. A first clutch K0 designed as a friction clutch can also be engaged at a differential speed. As a result, a “flywheel start” of the internal combustion engine 12 by the second electric machine 72 is possible (the inertial mass of the second electric machine 72 is utilized for starting the internal combustion engine 12).

The hybrid drive train 10″ from FIG. 6 is provided, in particular, for hybrid drive trains of the type in which the available electrical energy accumulator has relatively small dimensions. In this case, the possibilities of a purely electric driving operation with one or two electric machines are limited.

The hybrid drive train 10″ from FIG. 6 therefore provides that the second electric machine 72 is generally not utilized for driving the vehicle. Rather, the second electric machine 72 is generally operated only as a generator.

For this case, it is useful to equip the first electric machine 64 with the pre-ratio 80. In this way, high torques can be achieved in the purely electric driving operation, also without support of the second electric machine 72, only by the first electric machine 64. Since a purely electric driving operation with both electric machines is not necessary, a first clutch K0 can be omitted.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid drive train
12 internal combustion engine
14 input shaft
16 hybrid transmission arrangement
18 power distribution unit
20 driven wheels
22 control device
24 first input shaft
26 second input shaft
28 output shaft arrangement
30 first output shaft
32 second output shaft
34 first gear set plane
36 fixed gear
38 idler gear
40 idler gear
42 second gear set plane
44 fixed gear
46 idler gear
48 idler gear
50 third gear set plane
52 first output gearwheel
54 second output gearwheel
56 idler gear
58 drive gear (18)
60 first clutch plane
62 second clutch plane
64 first electric machine EM1
66 stator
68 housing
70 rotor
72 second electric machine EM2
74 electric machine shaft
76 gearwheel
80 pre-ratio
82 planetary gear set
84 ring gear
86 sun gear
88 planet carrier
A1-A5 axes
A-E gearshift clutches for gear-step gear sets
K0 first clutch
K3 second clutch
S1-S4 actuation devices
P parking interlock gear

1-15. (canceled)

16. A hybrid drive train (10) for a motor vehicle, comprising:
a drive shaft (14) connectable to an internal combustion engine (12);
a first input shaft connected to the drive shaft (14) or connectable to the drive shaft (14) via a first clutch (K0);
a second input shaft (26);
an output shaft arrangement (28);
a first electric machine (64) connected to the second input shaft (26); and
a transmission arrangement comprising
a first gear set plane (34) with at least one shiftable gear set via which the first input shaft (24) is connectable to the output shaft arrangement (28),
a second gear set plane (42) with at least one shiftable gear set via which the second input shaft (26) is connectable to the output shaft arrangement (28), and
a third gear set plane (50) with at least one gear set via which the output shaft arrangement (28) is connected to a power distribution unit (18) for driving driven wheels (20L, 20R).

17. The hybrid drive train of claim 16, wherein the first input shaft (24) and the second input shaft (26) are connectable via a second clutch (K3).

18. The hybrid drive train of claim 16, wherein the output shaft arrangement (28) comprises a first output shaft (30) and a second output shaft (32).

19. The hybrid drive train of claim 18, wherein the first gear set plane (34) comprises a fixed gear (36) connected to the first input shaft (24), an idler gear (38) mounted at the first output shaft (30), and an idler gear (40) mounted at the second output shaft (32).

20. The hybrid drive train of claim 18, wherein the second gear set plane (42) comprises a fixed gear (44) connected to the second input shaft (26), an idler gear (46) mounted at the first output shaft (30), and an idler gear (48) mounted at the second output shaft (32).

21. The hybrid drive train of claim 18, wherein the third gear set plane (50) comprises a first output gearwheel (52) fixed at the first output shaft (30) and a second output gearwheel (54) fixed at the second output shaft (32), the first and second output gearwheels (52, 54) engaged with an input element (58) of the power distribution unit (18).

22. The hybrid drive train of claim 16, wherein the third gear set plane (50) comprises an idler gear (56) rotatably mounted at the first input shaft (24) and engaged with a fixed gear (54), the fixed gear (54) fixed at an output shaft (32) of the output shaft arrangement (28).

23. The hybrid drive train of claim 22, wherein the idler gear (56) rotatably mounted at the first input shaft (24) is connectable to the first input shaft (24) by a gearshift clutch (D), the first input shaft (24) and the second input shaft (26) are connectable via a second clutch (K3), and the gearshift clutch (D) and a second clutch (K3) are alternately actuatable by an actuation device (S2).

24. The hybrid drive train of claim 16, wherein the third gear set plane (50) is arranged in an axial direction between the first gear set plane (34) and the second gear set plane (42).

25. The hybrid drive train of claim 16, wherein a first clutch plane (60) is arranged adjacent the first gear set plane (34).

26. The hybrid drive train of claim 25, wherein the first clutch plane (60) is arranged on an axial side of the first gear set plane (34) facing away from the third gear set plane (50).

27. The hybrid drive train of claim 16, wherein a second clutch plane (62) is arranged adjacent the second gear set plane (42).

28. The hybrid drive train of claim 27, wherein the second clutch plane (62) is arranged in an axial direction between the second gear set plane (42) and the third gear set plane (50).

29. The hybrid drive train of claim 16, wherein a starting torque ratio (i1) is formed by a gear set of the second gear set plane (42).

30. The hybrid drive train of claim 16, further comprising a second electric machine (72) connected to the first input shaft (24).

31. The hybrid drive train of claim 16, further comprising one or more of the first clutch (K0), a second clutch (K3), and at least one gearshift clutch (A, B, C, E) is configured as a dog clutch.

32. The hybrid drive train of claim 16, wherein a rotor (70) of the first electric machine (64″) is connected to the second input shaft (26) via a pre-ratio (80).
